(19) United States
(12) Patent Application Publication
(10) Pub. No.: US 2015/0165676 A1
(43) Pub. Date: Jun. 18, 2015

(54) PRINTING HEAD MODULE

(71) Applicants: XYZprinting, Inc., New Taipei City (TW); Cal-Comp Electronics & Communications Company Limited, New Taipei City (TW); Kinpo Electronics, Inc., New Taipei City (TW)

(72) Inventors: Chien-Chih Chen, New Taipei City (TW); Yi-Chin Tang, New Taipei City (TW); Yang-Teh Lee, New Taipei City (TW)

(73) Assignees: XYZprinting, Inc., New Taipei City (TW); Cal-Comp Electronics & Communications Company Limited, New Taipei City (TW); Kinpo Electronics, Inc., New Taipei City (TW)

(21) Appl. No.: 14/194,831

(22) Filed: Mar. 3, 2014

(30) Foreign Application Priority Data
Dec. 12, 2013 (TW) 102145914

(51) Int. Cl. B29C 67/00

(52) U.S. Cl. CPC B29C 67/0059; B29C 67/0085; B29K 2105/0067

(57) ABSTRACT

A printing head module is provided. The printing head module includes a bracket, a motor and a printing head. The bracket is slidingly disposed on a sliding rail and includes a containing cavity and at least one first locking portion. The motor is coupled to the bracket for driving the bracket to slide along the sliding rail. The printing head includes a material-supply channel, a nozzle and at least one second locking portion structurally corresponding to the first locking portion. The material-supply channel is connected to the nozzle, so that when the printing head is detachably disposed in the containing cavity, the second locking portion is locked with the first locking portion to fix the printing head to the bracket.

### CROSS-REFERENCE TO RELATED APPLICATION

This application claims the priority benefit of Taiwan application serial no. 102145914, filed on Dec. 12, 2013. The entirety of the above-mentioned patent application is hereby incorporated by reference herein and made a part of this specification.

### BACKGROUND OF THE INVENTION

1. Field of the Invention

The invention relates to a printing head module, and particularly, to a printing head module applicable to a three-dimensional (3-D) printing apparatus.

2. Description of Related Art

Along with advances in computer-aided manufacturing (CAM), the manufacturing industry has developed the technology of three-dimensional (3-D) printing, thereby rapidly fabricating products from an original design concept. In fact, the 3-D printing technology is a collective term referring to a series of rapid prototyping (RP) techniques, and the basic principle is laminate manufacture, wherein a rapid prototyping machine is used to form cross-sectional shapes of a workpiece in the X-Y plane through scanning, shift intermittently at a layer thickness in the Z coordinates, and ultimately form 3-D objects. The 3-D printing technology is applicable regardless of the geometric shapes and the RP technology produces excellent outputs in particular for complex parts, which saves efforts and processing time significantly. The 3-D printing technology is capable of presenting an object of a digital 3-D model designed by means of computer-aided design (CAD) software in the least time for the user to touch and actually feel the geometry of the model, or even to test the assemblability of the parts and possible functions.

However, in the current 3-D printing apparatuses that utilize the aforementioned rapid prototyping technology, a printing head is generally directly fixedly disposed on a bracket that is adapted to slide along a sliding rail, thus enabling the printing head to slide back and forth along the sliding rail so as to spray a hot-melt material onto a base of the 3-D printing apparatuses. With such arrangement, since the printing head is fixedly disposed on the slidable bracket, the printing head is relatively difficult or even impossible to be independently detached. Accordingly, cleaning, replacement or maintenance of the printing head is difficult. Therefore, current 3-D printing equipments are still very inconvenient in terms of maintenance and also take a lot of manpower.

### SUMMARY OF THE INVENTION

The invention provides a printing head module, wherein a printing head may be easily detached from a bracket.

The printing head module of the invention is adapted to slide along a sliding rail. The printing head module includes a bracket, a motor and a printing head. The bracket is slidingly disposed on the sliding rail and includes a containing cavity and at least one first locking portion. The motor is coupled to the bracket for driving the bracket to slide along the sliding rail. The printing head is detachably disposed in the containing cavity, and includes at least one second locking portion structurally corresponding to the first locking portion. When the printing head is disposed in the containing cavity, the second locking portion is locked with the first locking portion to fix the printing head to the bracket.

Based on the above, in the present invention, the first locking portion and the second locking portion structurally interferes with each other and are respectively disposed on the slidable bracket and the printing head. Accordingly, when the printing head is disposed in the containing cavity of the bracket, the first locking portion and the second locking portion are locked with each other to fix the printing head to the bracket, and this locking relationship may be easily released. In this way, the 3-D printing apparatus and the printing head module of the invention make it possible to easily detach and assemble the printing head for cleaning, replacement or maintenance of the same, which further improves the convenience in maintenance and use of the 3-D printing apparatus and the printing head module.

To make the above features and advantages of the invention more comprehensible, embodiments accompanied with drawings are described in detail as follows.

### BRIEF DESCRIPTION OF THE DRAWINGS

FIG. 1 is a schematic view of a 3-D printing apparatus according to an embodiment of the invention.

FIG. 2 is a schematic exploded view of a part of components of a printing head module according to an embodiment of the invention.

FIG. 3 is a schematic view of the printing head module in FIG. 2 after being assembled.

FIG. 4 is a schematic view of a second locking portion according to an embodiment of the invention.

FIG. 5 is a schematic cross-sectional view of a first locking portion locked with the second locking portion according to an embodiment of the invention.

FIG. 6 is a schematic view of a part of components of a printing head module according to an embodiment of the invention.

FIG. 7 is a schematic cross-sectional view of a printing head module according to an embodiment of the invention.

FIG. 8 is a schematic view of assembly of a fan and a heat dissipating block of a printing head module according to an embodiment of the invention.

FIG. 9 is a schematic view of assembly of a printing head and a heat dissipating block of a printing head module according to an embodiment of the invention.

### DETAILED DESCRIPTION OF DISCLOSED EMBODIMENTS

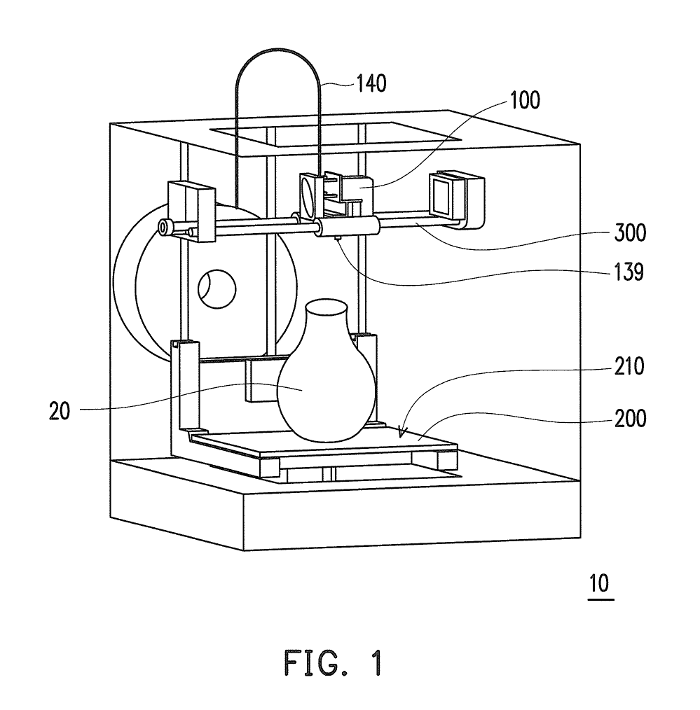

FIG. 1 is a schematic view of a 3-D printing apparatus according to an embodiment of the invention. Referring to FIG. 1, in the present embodiment, a 3-D printing apparatus 10 includes a printing head module 100, a base 200 and a sliding rail 300. The base 200 includes a carrying surface 210 for bearing a hot-melt material provided by the printing head module 100. The sliding rail 300 is disposed above the base 200. In the present embodiment, an extension direction of the sliding rail 300 is parallel to the carrying surface 210, the printing head module 100 is configured to slide back and forth along the sliding rail 300, and the base 200 may, for example, be parallel to and move relative to the printing head module 100. In detail, the 3-D printing apparatus 10 includes a control unit coupled to the printing head module 100 for reading and processing a digital 3-D model information. In this way, the control unit controls the printing head module 100 to move along the sliding rail 300 according to the digital 3-D model information. When moving, the printing head module 100 dispenses the hot-melt material layer by layer on the carrying surface 210, thereby forming a 3-D object 20.

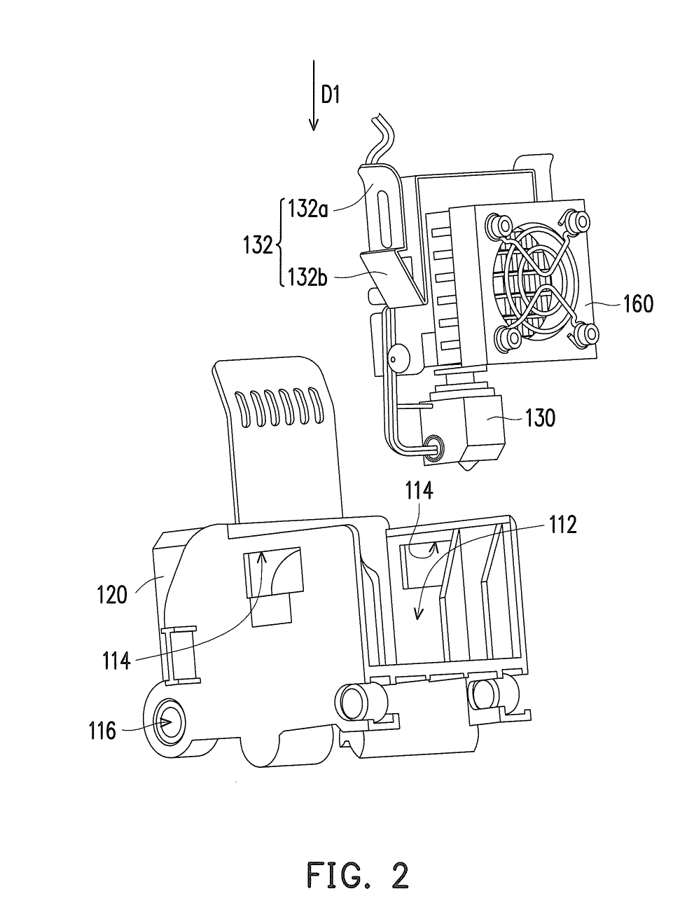

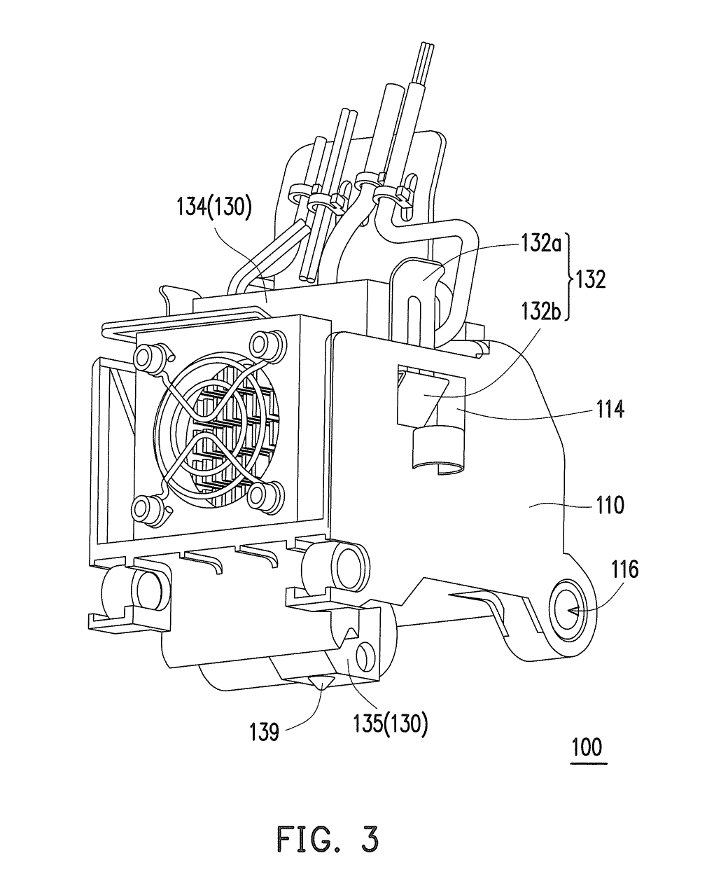

FIG. 2 is a schematic exploded view of a part of components of a printing head module according to an embodiment of the invention. FIG. 3 is a schematic view of the printing head module in FIG. 2 after being completely assembled. Referring to both FIGS. 2 and 3, in the present embodiment, the printing head module 100 includes a bracket 110, a motor 120 and a printing head 130. The bracket 110 is slidingly disposed on the sliding rail 300 as shown in FIG. 1. In the present embodiment, the bracket 110 includes a plurality of through holes 116 located at the bottom of the bracket 110, and the through holes are sleeved on the sliding rail 300. That is, the sliding rail 300 passes through the through holes 116 to enable the bracket 110 to slide back and forth along the sliding rail 300. The bracket 110 further includes a containing cavity 112 and at least one (two are shown) first locking portions 114. The motor 120 is coupled to the bracket 110 for driving the bracket 110 to slide along the sliding rail 300. In the present embodiment, the control unit of the 3-D printing apparatus, controls the motor 120 to drive the bracket 110 to slide along the sliding rail 300 according to the digital 3-D model information, so as to further control movement of the entire printing head module 100. The printing head 130 is detachably disposed in the containing cavity 112, and includes at least one (two are shown) second locking portions 132 structurally interfering with the first locking portion 114. When the printing head 130 is disposed in the containing cavity 112 along an assembly direction D1, the second locking portion 132 is automatically locked with the first locking portion 114 to fix the printing head 130 to the bracket 110.

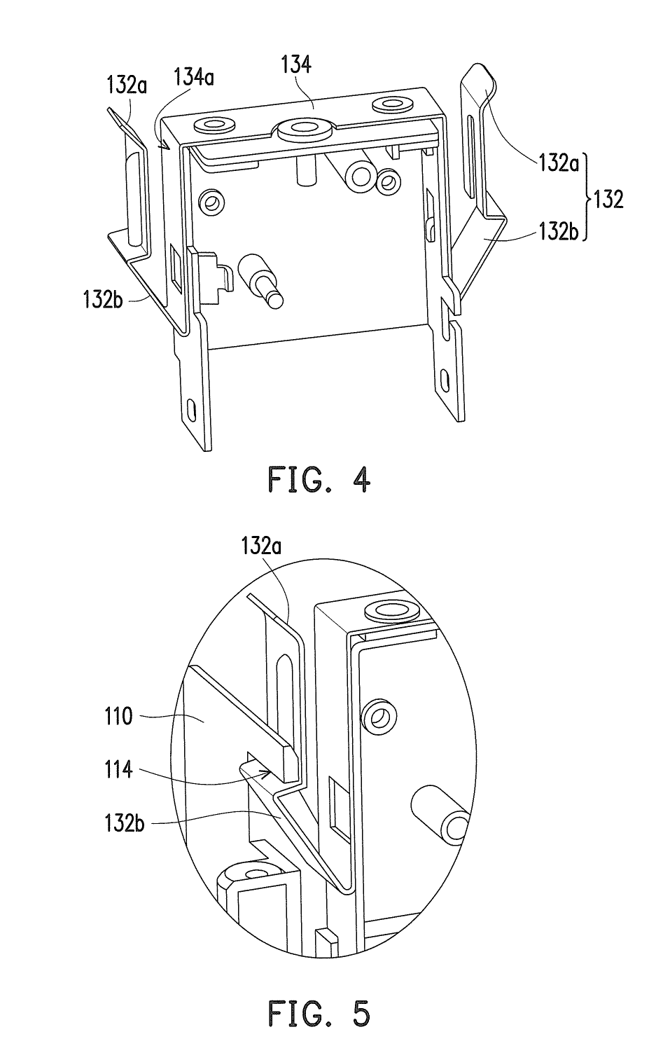

FIG. 4 is a schematic view of a second locking portion according to an embodiment of the invention. FIG. 5 is a schematic cross-sectional view of a first locking portion locked with the second locking portion according to an embodiment of the invention. Referring to FIGS. 3 to 5 together, specifically, the first locking portion 114 is an opening 114 as shown in FIG. 3. The second locking portion 132 is an elastic piece as shown in FIG. 4, which is disposed on a side surface 134a of the printing head 130. In the present embodiment, the printing head 130 further includes a casing 134 and a body 135 as shown in FIG. 3. FIG. 4 is a schematic view of the casing 134. The casing 134 covers the body 135, and the second locking portion 132 is fixedly disposed on the casing 134. The elastic piece 132 includes a protruding portion 132b corresponding to the opening 114, and a pressing portion 132a connected to the protruding portion 132b.

With such arrangement, when the printing head 130 is disposed in the containing cavity 112 along the assembly direction D1, an inner wall of the containing cavity 112 first touches a bottom of the protruding portion 132b to push the protruding portion 132b toward the side surface 134a. The protruding portion 132b just returns to its initial position when passing through the opening 114, such that the protruding portion 132b is locked with the opening 114 by passing through the opening 114. In this way, when the printing head 130 is disposed in the containing cavity 112, the second locking portion 132 is automatically locked with the first locking portion 114 to fix the printing head 130 to the bracket 110. In addition, when a user is detaching the printing head 130 from the bracket 110, they only need to press the pressing portion 132a toward the side surface 134a. Consequently, the pressing portion 132a causes the protruding portion 132b to move toward the side surface 134a, thereby releasing the protruding portion 132b from a structural interference with the opening 114. At this moment, the user may easily detach the printing head 130 from the bracket 110.

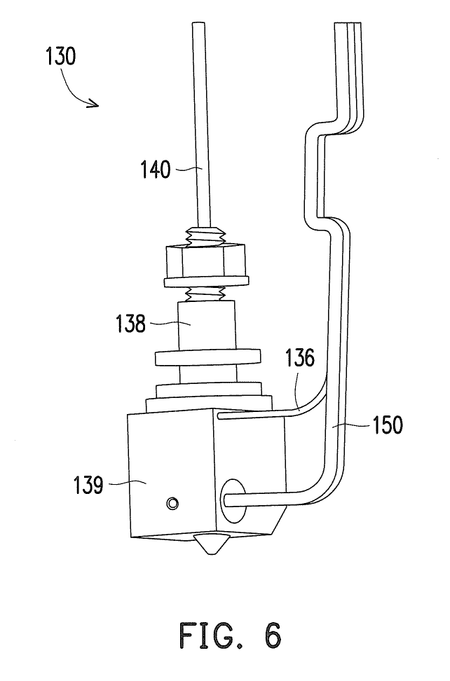

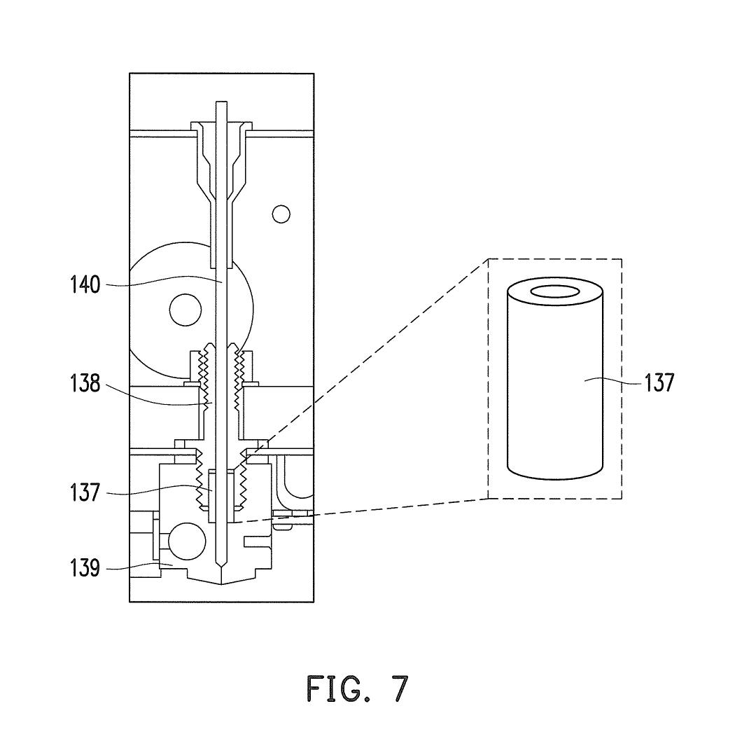

FIG. 6 is a schematic view of a part of components of a printing head module according to an embodiment of the invention. FIG. 7 is a schematic cross-sectional view of a printing head module according to an embodiment of the invention. Referring to FIGS. 6 and 7 together, in further detail, the printing head 130 includes a material-supply channel 138 and a nozzle 139. The material-supply channel 138 is connected to the nozzle 139. In addition, the printing head module 100 further includes at least one material-supply filament 140 and a heating unit 150. The material-supply filament 140 is connected to the material-supply channel 138 for supplying the hot-melt material. The hot-melt material is transmitted to the nozzle 139 through the material-supply channel 138. In the present embodiment, the material-supply filament 140 is a solid state filament composed of the hot-melt material, and is disposed in the material-supply channel 138 to be transmitted therethrough to the nozzle 139. The heating unit 150 heats the hot-melt material transmitted to the nozzle 139 to a molten state so as to form a molten base material. The molten base material is extruded from the printing head 130 and stacked layer by layer on the carrying surface 210, thereby forming a plurality of molten base material layers. The molten base material layers are stacked together to form the 3-D object 20. In the present embodiment, the hot-melt material is, for example, a hot-melt high-molecular material such as polylactic acid (PLA) or acrylonitrile butadiene styrene (ABS) resin.

In addition to the above, the printing head 130 further includes a temperature sensing unit 136 coupled to the nozzle 139 for sensing a temperature of the nozzle 139. In the present embodiment, the control unit of the 3-D printing apparatus 10 obtains the temperature of the nozzle 139 by means of the temperature sensing unit 136, thereby further controlling the temperature of the nozzle 139 within a specific range. It is noted that the temperature of the nozzle 139 may be controlled to be substantially higher than a melting point temperature of the hot-melt material, so that the hot-melt material may be melted into the molten base material.

In the present embodiment, the printing head 130 further includes a heat insulation pipe 137 disposed in the material-supply channel 138, as shown in FIG. 7. The heat insulation pipe 137 includes a via adapted to contain the material-supply filament 140. The nozzle 139 in the present embodiment is a metal nozzle, thus allowing heat energy generated by the heating unit 150 to be rapidly transmitted throughout the entire nozzle 139. The heat insulation pipe 137 is disposed in the material-supply channel 138 to provide thermal insulation against high temperature of the nozzle 139, so as to prevent a situation where a temperature of the material-supply channel 138 is excessively high so that the hot-melt material therein is softened and melted too quickly.

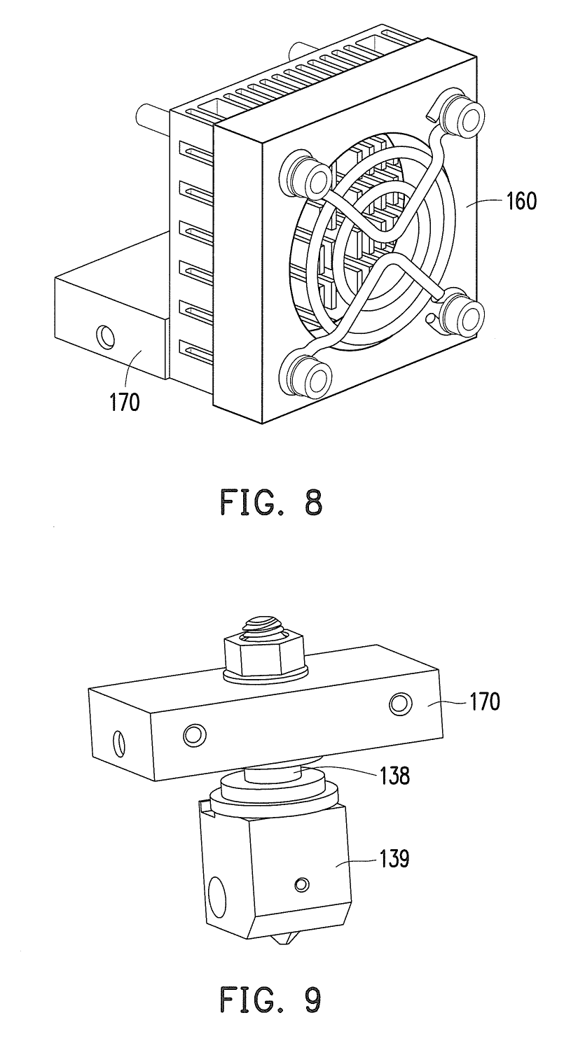

FIG. 8 is a schematic view of assembly of a fan and a heat dissipating block of a printing head module according to an embodiment of the invention. FIG. 9 is a schematic view of assembly of a printing head and a heat dissipating block of a printing head module according to an embodiment of the invention. Referring to FIGS. 8 and 9 together, in addition to the above arrangement, the printing head module 100 further includes a fan 160 and a heat dissipating block 170 for performing heat dissipation on the material-supply channel 138. The fan 160 is disposed on the printing head 130, and an air outlet of the fan 160 faces the material-supply channel 138 to provide a cooling airflow to the material-supply channel 138. The heat dissipating block 170 is sleeved on the material-supply channel 138, so that the heat of the material-supply channel 138 is directly transmitted to the heat dissipating block 170. Moreover, the heat dissipating block 170 is connected to the fan 160, thus enabling the fan 160 to perform heat dissipation on the heat dissipating block 170 by providing a cooling airflow thereto. In the present embodiment, the fan 160 includes a plurality of bolts as shown in FIG. 8. The bolts are respectively locked with the casing 134 of the printing head 130 and the heat dissipating block 170, thereby fixing a connecting relationship among the printing head 130, the heat dissipating block 170 and the fan 160. Accordingly, the temperature of the material-supply channel 138 is decreased through the cooling airflow provided by the fan 160. In addition, the heat energy of the material-supply channel 138 is transmitted to the heat dissipating block 170, and the heat dissipating block 170 is then cooled by the fan 160. As a result, the temperature of the material-supply channel 138 is decreased so as to prevent the hot-melt material in the material-supply channel 138 from being softened and melted too quickly.

In summary, in the present invention, the first locking portion and the second locking portion structurally engaged with each other and are respectively disposed on the slidable bracket and the printing head. Accordingly, when the printing head is disposed in the containing cavity of the bracket, the first locking portion and the second locking portion are automatically locked with each other to fix the printing head to the bracket. Moreover, the structural interference between the first locking portion and the second locking portion is released by pressing the pressing portion of the second locking portion, which enables the printing head to be easily separated from the bracket. In this way, the 3-D printing apparatus and the printing head module of the invention make it possible to easily detach and assemble the printing head for cleaning, replacement or maintenance of the same, which further increases the convenience in use and maintenance of the 3-D printing apparatus and the printing head module.

Although the invention has been described with reference to the above embodiments, it will be apparent to one of ordinary skill in the art that modifications to the described embodiments may be made without departing from the spirit of the invention. Accordingly, the scope of the invention will be defined by the attached claims and not by the above detailed descriptions.

What is claimed is:

1. A printing head module, adapted to slide along a sliding rail for forming a three-dimensional (3-D) object on a carrying surface of a base, the printing head module comprising:
a bracket slidingly disposed on the sliding rail and comprising a containing cavity and at least one first locking portion;
a motor coupled to the bracket for driving the bracket to slide along the sliding rail; and
a printing head comprising a material-supply channel, a nozzle and at least one second locking portion structurally cooperated with the first locking portion, wherein the material-supply channel is connected to the nozzle, so that the printing head is detachably disposed in the containing cavity, and the second locking portion is locked with the first locking portion to fix the printing head to the bracket.

2. The printing head module as claimed in claim 1, wherein the first locking portion comprises a locking opening and the second locking portion comprises an elastic piece disposed on one side surface of the printing head, wherein the elastic piece comprises a protruding portion corresponding to the opening and a pressing portion connected to the protruding portion, the protruding portion is adapted to pass through the opening to be structurally interfered with the opening, and when the pressing portion is pressed, the pressing portion causes the protruding portion to move toward the side surface so as to release the structural interference between the protruding portion and the opening.

3. The printing head module as claimed in claim 1, wherein the printing head further comprises a casing and a body, the casing covers the body and the second locking portion is fixedly disposed on the casing.

4. The printing head module as claimed in claim 1, wherein the printing head module further comprises:
at least one material-supply filament connected to the material-supply channel for supplying a hot-melt material, wherein the hot-melt material is transmitted to the nozzle through the material-supply channel; and
a heating unit coupled to the printing head and configured to heat the hot-melt material in the nozzle, so as to melt the hot-melt material into a molten base material, and the molten base material is extruded from the nozzle.

5. The printing head module as claimed in claim 1, wherein the printing head further comprises a temperature sensing unit coupled to the nozzle for sensing a temperature of the nozzle.

6. The printing head module as claimed in claim 1, wherein the printing head further comprises a heat insulation pipe disposed in the material-supply channel.

7. The printing head module of claim 1, wherein the printing head module further comprises a fan disposed on the printing head, and an air outlet of the fan faces the material-supply channel.

8. The printing head module as claimed in claim 7, wherein the printing head module further comprises a heat dissipating block disposed on the material-supply channel and connected to the fan.

9. The printing head module as claimed in claim 1, wherein the bracket further comprises a plurality of through holes, and the sliding rail passes through the through holes so as to adapt the bracket to slide along the sliding rail.
